(19) United States
(12) Patent Application Publication
(10) Pub. No.: US 2024/0159871 A1
(43) Pub. Date: May 16, 2024

(54) UNSUPERVISED OBJECT DETECTION FROM LIDAR POINT CLOUDS

(71) Applicant: WAABI Innovation Inc., Toronto (CA)

(72) Inventors: Lunjun ZHANG, Toronto (CA); Yuwen XIONG, Toronto (CA); Sergio CASAS ROMERO, Toronto (CA); Mengye REN, New York City, NY (US); Raquel URTASUN, Toronto (CA); Angi Joyce YANG, Toronto (CA)

(21) Appl. No.: 18/506,682

(22) Filed: Nov. 10, 2023

Related U.S. Application Data
(60) Provisional application No. 63/424,856, filed on Nov. 11, 2022.

(51) Int. Cl. G01S 7/48; G01S 17/89

(52) U.S. Cl. CPC G01S 7/4802; G01S 17/89

(57) ABSTRACT

Unsupervised object detection from lidar point clouds includes forecasting a set of new positions of a set of objects in a geographic region based on a first set of object tracks to obtain a set of forecasted object positions, and obtaining a new LiDAR point cloud of the geographic region. A detector model processes the new LiDAR point cloud to obtain a new set of bounding boxes around the set of objects detected in the new LiDAR point cloud. Object detection further includes matching the new set of bounding boxes to the set of forecasted object positions to generate a set of matches, updating the first set of object tracks with the new set of bounding boxes according to the set of matches to obtain an updated set of object tracks, and filtering, after updating, the updated set of object tracks to remove object tracks failing to satisfy a track length threshold, to generate a training set of object tracks. The object detection further includes selecting at least a subset of the new set of bounding boxes that are in the training set of object tracks, and retraining the detector model using the at least the subset of the new set of bounding boxes.

### CROSS-REFERENCE TO RELATED APPLICATIONS

This application is a non-provisional application of, and thereby claims

benefit to U.S. Patent Application Ser. No. 63/424,856 filed on Nov. 11, 2022, which is incorporated herein by reference in its entirety.

### BACKGROUND

LiDAR, which stands for Light Detection and Ranging, is a remote sensing method that uses light in the form of a pulsed laser to measure ranges (variable distances) to various objects. LiDAR can provide accurate geometric measurements of the three-dimensional (3D) world. Unfortunately, dense LiDAR sensors are expensive, and the point clouds captured by low-beam LiDAR are often sparse, especially at far distances.

LiDAR is used in semi-autonomous and fully autonomous systems. For example, to effectively perceive an autonomous system's surroundings, autonomous systems may exploit LiDAR as the major sensing modality since the autonomous system can capture well the 3D geometry of the world.

LiDAR sensors use time-of-flight to obtain measurements of a surrounding region. Specifically, a LiDAR sensor may scan the environment by rotating emitter-detector pairs (e.g., beams) around the azimuth. At every time step, each emitter emits a light pulse which travels until the beam hits a target, gets reflected, and is received by the detector. Distance is measured by calculating the time of travel. The result of a beam is a LiDAR point in a LiDAR point cloud. Through multiple such beams, the full LiDAR point cloud is generated. Due to the design, the captured point cloud density inherently decreases as the distance to the sensor increases. For distant objects, often only a few LiDAR points are captured, which greatly increases the difficulty of 3D perception. Poor weather conditions and fewer beams increase the sparsity problem.

Object detection using LiDAR point clouds is dependent on a computer system being able to group LiDAR points as belonging to the same object. Generally, machine learning models use supervised, manual training data to learn which LiDAR points to a group. Namely, a human manually labels the LiDAR points in the LiDAR point cloud as belonging to the same single object, and then the training of the machine learning model uses that as the ground truth for training the machine learning model. However, the amount of training data is limited as manual data generation is performed. With limited amounts of ground truth data, machine learning models may be inadequate in correctly identifying objects.

### SUMMARY

In general, in one aspect, one or more embodiments relate to a method that includes forecasting a set of new positions of a set of objects in a geographic region based on a first set of object tracks to obtain a set of forecasted object positions, and obtaining a new LiDAR point cloud of the geographic region. A detector model processes the new LiDAR point cloud to obtain a new set of bounding boxes around the set of objects detected in the new LiDAR point cloud. The method further includes matching the new set of bounding boxes to the set of forecasted object positions to generate a set of matches, updating the first set of object tracks with the new set of bounding boxes according to the set of matches to obtain an updated set of object tracks, and filtering, after updating, the updated set of object tracks to remove object tracks failing to satisfy a track length threshold, to generate a training set of object tracks. The method further includes selecting at least a subset of the new set of bounding boxes that are in the training set of object tracks, and retraining the detector model using the at least the subset of the new set of bounding boxes.

In general, in one aspect, one or more embodiments relate to a system that includes one or more computer processors and a non-transitory computer readable medium comprising computer readable program code for causing the one or more computer processors to perform operations. The operations include forecasting a set of new positions of a set of objects in a geographic region based on a first set of object tracks to obtain a set of forecasted object positions, and obtaining a new LiDAR point cloud of the geographic region. A detector model processes the new LiDAR point cloud to obtain a new set of bounding boxes around the set of objects detected in the new LiDAR point cloud. The operations further include matching the new set of bounding boxes to the set of forecasted object positions to generate a set of matches, updating the first set of object tracks with the new set of bounding boxes according to the set of matches to obtain an updated set of object tracks, and filtering, after updating, the updated set of object tracks to remove object tracks failing to satisfy a track length threshold, to generate a training set of object tracks. The operations further include selecting at least a subset of the new set of bounding boxes that are in the training set of object tracks, and retraining the detector model using the at least the subset of the new set of bounding boxes.

In general, in one aspect, one or more embodiments relate to a non-transitory computer readable medium comprising computer readable program code for causing a computer system to perform operations. The operations include forecasting a set of new positions of a set of objects in a geographic region based on a first set of object tracks to obtain a set of forecasted object positions, and obtaining a new LiDAR point cloud of the geographic region. A detector model processes the new LiDAR point cloud to obtain a new set of bounding boxes around the set of objects detected in the new LiDAR point cloud. The operations further include matching the new set of bounding boxes to the set of forecasted object positions to generate a set of matches, updating the first set of object tracks with the new set of bounding boxes according to the set of matches to obtain an updated set of object tracks, and filtering, after updating, the updated set of object tracks to remove object tracks failing to satisfy a track length threshold, to generate a training set of object tracks. The operations further include selecting at least a subset of the new set of bounding boxes that are in the training set of object tracks, and retraining the detector model using the at least the subset of the new set of bounding boxes.

Other aspects of the invention will be apparent from the following description and the appended claims.

### BRIEF DESCRIPTION OF DRAWINGS

FIG. 1 shows an autonomous system with a virtual driver in accordance with one or more embodiments.

FIG. 2 shows an object detection system in accordance with one or more embodiments of the invention.

FIG. 3 shows a diagram of an example of a LiDAR point cloud and a three-dimensional (3D) grid for voxelized LiDAR in accordance with one or more embodiments of the invention.

FIG. 4 shows a flowchart for performing initial training and the use of a detector model in accordance with one or more embodiments of the invention.

FIG. 5 shows a flowchart for applying a sparsity simulation filter in accordance with one or more embodiments of the invention.

FIG. 6 shows a flowchart for iterative training and the use of a detector model in accordance with one or more embodiments of the invention.

FIG. 7 shows an example of one or more embodiments with a LiDAR point cloud and a detector for an autonomous system in accordance with one or more embodiments.

FIG. 8 shows an example of iterative training with matching in accordance with one or more embodiments.

FIGS. 9A and 9B show a computing system in accordance with one or more embodiments of the invention.

Like elements in the various figures are denoted by like reference numerals for consistency.

### DETAILED DESCRIPTION

Embodiments are directed to unsupervised iterative training of a detector model that detects objects in LiDAR point clouds. The detector model is a machine learning model that is configured to identify the location of objects by LiDAR points in a LiDAR point cloud. Machine learning models, such as the detector model, generally use different set of features than a human would use in order to recognize objects. The features are learned through a training process, whereby the weights of the features in the detector model are gradually updated. A detector model uses labeled LiDAR data as training data. When insufficient labeled LiDAR data exists, then the detector model may not be as accurate as possible.

One or more embodiments provide a technique to automatically generate training data and iteratively update the detector model. To generate training data, when an object is detected in multiple point clouds over time, the detection of the object is determined to be accurate. Thus, the LiDAR point cloud with the object labeled may be used to further train the detector model as new training data. When used for training, the LiDAR point cloud is filtered to imitate the sparsity of LiDAR data far regions.

As specified above, embodiments rely on the same object being detected in multiple point clouds. Notably, objects often move between captures of LiDAR point clouds, and the detector model outputs the boundaries of the object without relating the object to prior point clouds. In one or more embodiments, to identify that the same object is present in multiple point clouds, object tracks are used. From the object tracks, a set of forecasted object positions of the objects are predicted. The set of forecasted object positions may be forecasted based on the current position, velocity, and other information in the object track. A new LiDAR point cloud is obtained and processed by the detector model to obtain a new set of bounding boxes around objects in the new LiDAR point cloud. A matching process is performed to match the object tracks of previously detected objects to the new bounding boxes by comparing the new bounding boxes to the set of forecasted object positions. When matches are found, the object tracks are updated with the matching bounding box. The process may iteratively repeat with each new LiDAR point cloud. Objects that have object tracks satisfying a minimum length threshold may have the corresponding bounding box used in training the detector model while the remaining objects are ignored for the purposes of training.

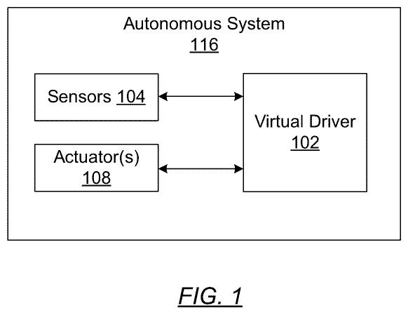

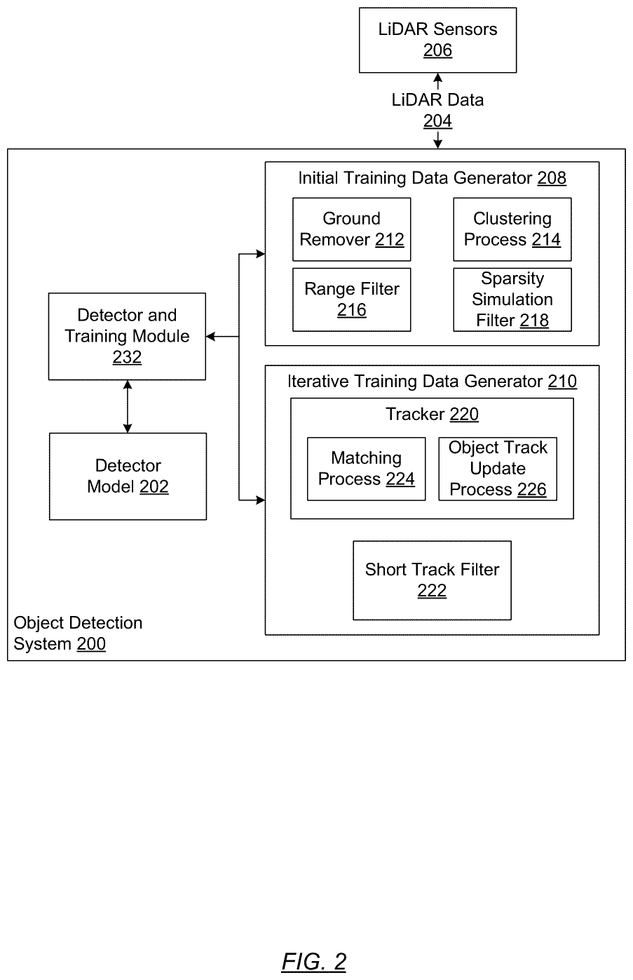

One or more embodiments may be used by an autonomous system that uses LiDAR to detect objects. Turning to the Figures, FIGS. 1 and 2 show example diagrams of the autonomous system and virtual driver. Turning to FIG. 1, an autonomous system (116) is a self-driving mode of transportation that does not require, but may use, a human pilot or human driver to move and react to the real-world environment. The autonomous system (116) may be completely autonomous or semi-autonomous. As a mode of transportation, the autonomous system (116) is contained in a housing configured to move through a real-world environment. Examples of autonomous systems include self-driving vehicles (e.g., self-driving trucks and cars), drones, airplanes, robots, etc.

The autonomous system (116) includes a virtual driver (102) which is the decision-making portion of the autonomous system (116). The virtual driver (102) is an artificial intelligence system that learns how to interact in the real world and interacts accordingly. The virtual driver (102) is the software executing on a processor that makes decisions and causes the autonomous system (116) to interact with the real-world including moving, signaling, and stopping or maintaining a current state. Specifically, the virtual driver (102) is decision making software that executes on hardware (not shown). The hardware may include a hardware processor, memory, or other storage device, and one or more interfaces. A hardware processor is any hardware processing unit that is configured to process computer readable program code and perform the operations set forth in the computer readable program code.

A real-world environment is the portion of the real world through which the autonomous system (116), when trained, is designed to move. Thus, the real-world environment may include concrete and land, construction, and other objects in a geographic region along with agents. The agents are the other objects in the real-world environment that are capable of moving through the real-world environment. Agents may have independent decision-making functionality. The independent decision-making functionality of the agent may dictate how the agent moves through the environment and may be based on visual or tactile cues from the real-world environment. For example, agents may include other autonomous and non-autonomous transportation systems (e.g., other vehicles, bicyclists, robots), pedestrians, animals, etc.

In the real world, the geographic region is an actual region within the real-world that surrounds the autonomous system. Namely, from the perspective of the virtual driver, the geographic region is the region through which the autonomous system moves.

The real-world environment changes as the autonomous system (116) moves through the real-world environment. For example, the geographic region may change, and the agents may move positions, including new agents being added and existing agents leaving.

In order to interact with the real-world environment, the autonomous system (116) includes various types of sensors (104), such as LiDAR sensors amongst other types, which are used to obtain measurements of the real-world environment, and cameras that capture images from the real-world environment. LiDAR (i.e., the acronym for “light detection and ranging”) is a sensing technique that uses light in the form of a pulsed laser to measure ranges (variable distances) to various objects in an environment. The autonomous system (116) may include other types of sensors as well. The sensors (104) provide input to the virtual driver (102).

In addition to sensors (104), the autonomous system (116) includes one or more actuators (108). An actuator is hardware and/or software that is configured to control one or more physical parts of the autonomous system based on a control signal from the virtual driver (102). In one or more embodiments, the control signal specifies an action for the autonomous system (e.g., turn on the blinker, apply breaks by a defined amount, apply accelerator by a defined amount, turn the steering wheel or tires by a defined amount, etc.). The actuator(s) (108) are configured to implement the action. In one or more embodiments, the control signal may specify a new state of the autonomous system and the actuator may be configured to implement the new state to cause the autonomous system to be in the new state. For example, the control signal may specify that the autonomous system should turn by a certain amount while accelerating at a predefined rate, while the actuator determines and causes the wheel movements and the amount of acceleration on the accelerator to achieve a certain amount of turn and acceleration rate.

Although not shown in FIG. 1, embodiments may be used in a virtual environment, such as when the virtual driver is being trained and/or tested in a simulated environment created by a simulator. In such a scenario, to the virtual driver, the simulated environment appears as the real world environment.

In one or more embodiments, the virtual driver of the autonomous system or another component may include an object detection system. However, the object detection system may be used outside of the technological environment of the autonomous system. For example, the object detection system may be used in conjunction with virtually any system that uses LiDAR data.

FIG. 2 shows a schematic diagram of an object detection system (200). The object detection system (200) is a machine learning framework that is configured to train a detector model (202) and use the detector model (202) to detect objects in LiDAR data (204) from LiDAR sensors (206). In addition to the detector model (202), the object detection system (200) may include an initial training data generator (208), an iterative training data generator (210), and a detector and training module (232). Each of these components is described below.

The LiDAR sensors (206) are virtual or real LiDAR sensors. The LiDAR sensors 206) are configured to provide LiDAR data to the object detection system (200). For example, the LiDAR sensors (206) may be the real LiDAR sensors as described above with reference to FIG. 1, or a virtualized version thereof

The detector model (202) is a machine learning model that is configured to detect objects in the LiDAR data (204). For example, the detector model (202) may include multiple network layers, such as a convolutional neural network (CNN), residual network layers, and/or other computer vision based machine learning network layers. As another example, the detector model (202) may be an autoencoder decoder model that encodes a scene such that the decoder model decodes the scene into a set of individual objects during reconstruction. The detector model (202) may use completely unsupervised training or a combination of supervised and unsupervised training.

The detector and training module (232) is software configured to train the detector model (202) and trigger the detector model (202) to detect objects in LiDAR data (204). Specifically, the detector and training module (232) may be configured to automatically manage the performance of the detector model (202). The detector and training module (232) may interface with the initial training data generator (208) for the initial training and the iterative training data generator (210) for the iterative training. Although FIG. 2 shows the detector and training module (232), the initial training data generator (208), and the iterative training data generator (210) as separate components, the components may be combined in virtually any manner without departing from the scope of the claims.

The initial training data generator (208) is software that is configured to automatically generate an initial set of training data from the LiDAR data (204). The initial training data generator (208) includes a ground remover (212), a clustering process (214), a range filter (216), and a sparsity simulation filter (218). The ground remover (212) is configured to estimate and remove LiDAR points that are part of the ground from a LiDAR point cloud. The ground remover (212) may be configured to fit a linear plane to the LiDAR points as an estimate of ground, and then remove the LiDAR points that correspond to the ground.

The clustering process (214) is configured to cluster LiDAR points to generate an estimate of objects or ground. For example, an initial iteration of the clustering process may be performed as part of removing ground. Another iteration of the clustering process may be to provide an initial estimate of objects in the LiDAR point cloud.

The range filter (216) is configured to filter LiDAR points that do not satisfy a distance threshold. The distance threshold is a threshold on the distance from an identified location, such as the position of the LiDAR sensor, to the LiDAR point. In one or more embodiments, the distance threshold is a configurable parameter that is set to differentiate between a sparse far region from a near region with a higher density of LiDAR beams. In the sparse far region, the estimation by the clustering process may be poor because sparse LiDAR beams reflecting off of an object result in sparse LiDAR points that may not be clustered even though an object exists. Thus, to improve the accuracy of the initial training data, the range filter (216) may exclude the farther regions as defined by the distance threshold.

The sparsity simulation filter (218) is configured to imitate sparsity in far regions, for near region LiDAR data. As discussed above, certain regions are sparser. A detector model (202) trained only on point clouds of the denser regions may not function as accurately in the sparser regions. However, as explained above, the training LiDAR data in the sparser regions may miss objects. To accommodate both considerations, the sparsity simulation filter (218) adds noise to the training data. For example, the sparsity simulation filter is configured to remove LiDAR points from the training data to emulate sparsity in the initial training data.

Continuing with FIG. 2, the iterative training data generator (210) is software that is configured to generate iterative training data automatically and iteratively. Iterative training data is training data that is generated over time when the detector model is in use. The iterative training data generator (210) includes a tracker (220) and a short track filter (222). The tracker (220) is configured to track objects through multiple LiDAR data captures. Namely, the tracker (220) tracks the detection of an object over time to create object tracks. An object track is a path that the object takes. The object track may be identified by the location and size of the set of bounding boxes that are associated with the same object, and the heading.

The tracker (220) includes a matching process (224) and an object track update process (226). The matching process (224) is configured to match a detected bounding box of an object to a previously detected object track. Specifically, the matching process is configured to relate bounding boxes detected in a new LiDAR data acquisition with prior determined object tracks based on an estimation as to whether the bounding box is around the same object as the corresponding prior determined object track. The object track update process (226) is configured to update the object track with the new bounding box when a match is found. Namely, the object track update process is configured to add the bounding box for the object to the object track for the object based on identifying the match. In one or more embodiments, the tracker (220) with the matching process (224) and the object track update process (226) may configured to operate in both temporal directions. Specifically, the tracker is configured to create a forward-in-time object track and a backward-in-time object track.

The short track filter (222) is configured to filter object tracks that are less than a track length threshold. In one or more embodiments, the track length threshold is a threshold on the number of bounding boxes in the track. Other metrics for track length may be used without departing from the scope of the claims. Track length may be used as a proxy for determining the accuracy of an object detection. A detection of the same object over time may be identified as a more dependable or accurate detection while an object detected once and not detected again may be indicative of an inaccurate detection. By filtering out the detection of objects that have only short tracks, the resulting objects may be deemed more accurate.

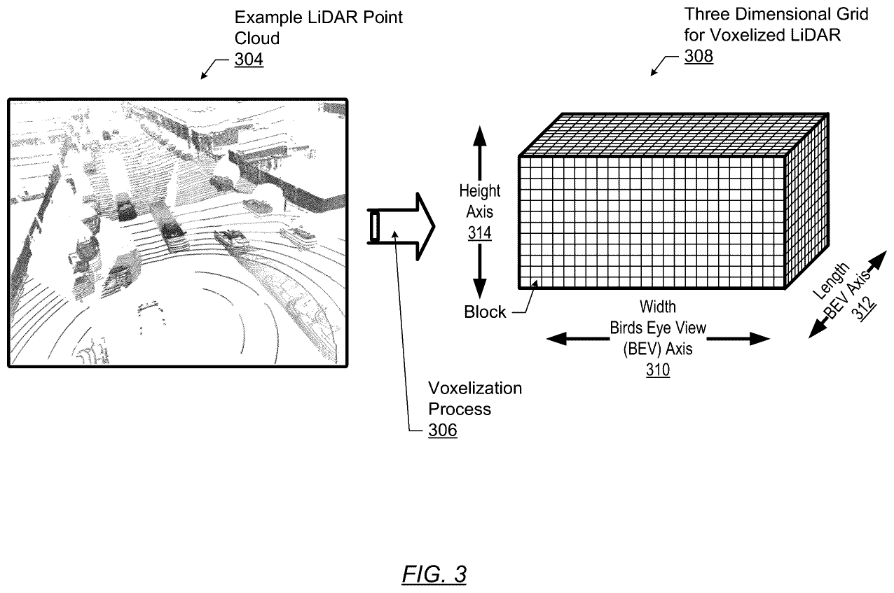

LiDAR data (204) may be received as a list of LiDAR points. The LiDAR data, when received, is a list of LiDAR points. The LiDAR points may each have a distance, direction, and intensity. The distance and direction may be with respect to the LiDAR sensor. Turning to FIG. 3, the list of LiDAR points may be translated to a LiDAR point cloud, which specifies the points in 3D space. FIG. 3 shows an example of a LiDAR point cloud (304). In one or more embodiments, LiDAR points in the LiDAR point cloud are defined in the cartesian coordinate system (e.g., with an x, y, and z axes) that are a scaled model of the 3D geographic region.

A voxelization process (306) may be performed on the LiDAR point cloud to generate a 3D grid for voxelized LiDAR. As with the LiDAR point cloud (304), the 3D grid (306) is a grid having three axes in one or more embodiments. The first two axes are a width birds eye view (BEV) axis (310) and a length BEV axis (312). The width birds eye view (BEV) axis (310) and the length BEV axis (312) are axes that are parallel to the ground. The third axis is perpendicular to the width and length axis. The third axis is a height axis (314) that corresponds to elevation from the Earth. For example, the width and length axis may be substantively planar to the longitudinal and latitudinal axes while the third axis is parallel to the height axis and corresponds to elevation.

The 3D grid (308) is partitioned into blocks, whereby a one-to-one mapping exists between blocks in the grid and subregions of the geographic region. The location of the block with respect to the grid defines the corresponding subregion in the geographic region to which the block refers. Accordingly, locations in the geographic region are deemed to be mapped to a particular block of the 3D LiDAR image when the location is in a subregion that is mapped to or referenced by the block.

The size of each subregion mapped to each block is dependent on and defined by the resolution of the 3D grid (308). In one or more embodiments, the resolution of the 3D LiDAR image (308) is configurable. Further, multiple LiDAR points may be mapped to the same block of the 3D LiDAR image (308). The voxelization process (306) may translate the LiDAR point cloud to a binary 3D grid. A block has a value of zero or one based on whether the block is occupied. For example, in the binary grid, blocks in the grid have one if at least one LiDAR point is at a location in the subregion mapped to the block and zero otherwise. Nonbinary grids may be used without departing from the scope of the claims.

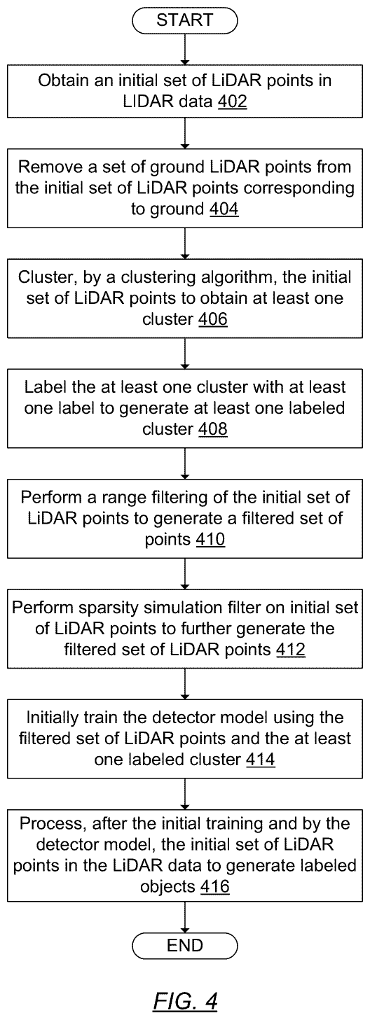

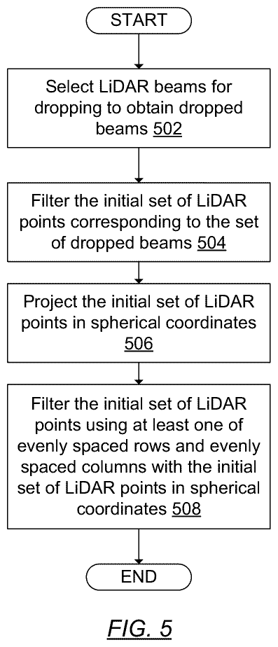

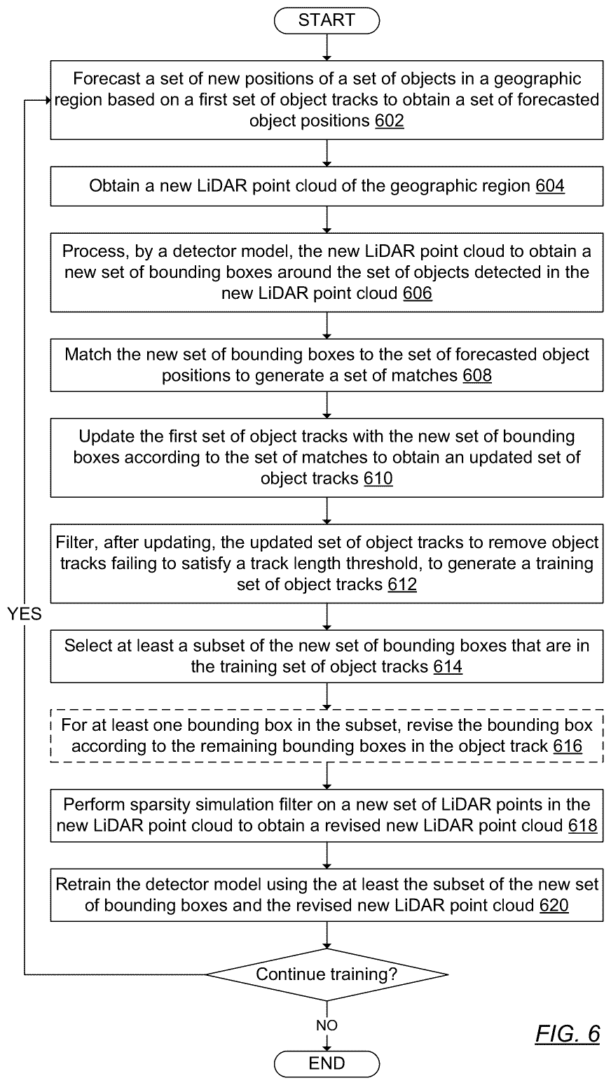

Turning to the flowcharts, FIG. 4 shows a flowchart for performing the initial training of a detector model. FIG. 5 shows a flowchart for performing sparsity simulation filtering in accordance with one or more embodiments. FIG. 6 shows a flowchart for performing iterative training in accordance with one or more embodiments. While the various steps in these flowcharts are presented and described sequentially, at least some of the steps may be executed in different orders, may be combined, or omitted, and at least some of the steps may be executed in parallel. Furthermore, the steps may be performed actively or passively.

FIG. 4 shows a flowchart for performing initial training and the use of a detector model in accordance with one or more embodiments. Turning to FIG. 4, in Block 402, an initial set of LiDAR points in LiDAR data is obtained. In the autonomous system, one or more LiDAR sweeps may be performed by one or more real LiDAR sensors. As another example, LiDAR sweeps may be performed by one or more LiDAR sensors that are part of a different system. To perform a LiDAR sweep, the light pulse is transmitted by the LiDAR transmitter of the LiDAR sensor. The light pulse may reflect off of an object, albeit unknown, in the environment, and the time and intensity for the reflected light pulse to return to the receiver is determined. The time is used to determine the distance to an object. The result is a LiDAR point in the LiDAR data. For the LiDAR sweep, multiple light pulses are transmitted at a variety of angles, and multiple reflected lights are received to obtain multiple points in the LiDAR point cloud. The LiDAR point cloud may be obtained as a list of LiDAR points. The list may be translated to a LiDAR point cloud. One or more sensing frames may be combined into a LiDAR point cloud, whereby a sensing frame is a scan of the geographic region.

Rather than using a real LiDAR sensor, the simulator, using a sensor simulation model for the LiDAR sensor, may generate simulated LiDAR input data. Specifically, the simulator may generate a scene and render the scene. Machine learning models that are part of the simulator may determine the intensity of the LiDAR points to the various objects in the scene based on the location of the virtual LiDAR sensor in the scene. The relative positions of the virtual LiDAR sensor to the locations of the objects are used to determine the respective distance. The result is a simulated set of LiDAR points that mimic real LiDAR data for a particular simulated scene. The simulated LiDAR data may be of virtually any resolution. For example, the simulated LiDAR data may match the resolution of a real LiDAR sensor.

In Block 404, a set of ground LiDAR points corresponding to the ground are removed from the initial set of LiDAR points. In one or more embodiments, the ground is not an object to detect but still may reflect LiDAR beams so as to have LiDAR points in the LiDAR point cloud. Thus, prior to training, the ground is removed. In general, removing the ground may be performed by fitting a ground plane (e.g., a flat surface) to the LiDAR point cloud. Points below the fitted ground plane are removed.

By way of a more specific example of removing ground, a first round of a clustering process may be performed to define a height having a threshold (e.g., fiftieth, thirtieth, etc.) percentile of LiDAR points on the height axis of non-outlier points. The threshold percentile of LiDAR points means that the percentage of LiDAR points above the defined height is the threshold percentage of the total number of points. The linear plane is then fit to the LiDAR points below the defined height. Multiple rounds of ground fitting (i.e., fitting the linear plane) may be performed, with a small negative offset applied to the height axis proportionally and LiDAR points above the fitted plane removed after the first round and before the second round of fitting. The ground is removed by removing points from the LiDAR point cloud that are below the linear plane.

In Block 406, a clustering algorithm clusters the initial set of LiDAR points to obtain at least one cluster. Clustering is performed after the ground is removed to obtain at least one cluster. In one or more embodiments, any clustering performed to remove the ground is ignored and a new clustering process is performed.

For persistence-based clustering, the point-wise number of neighbors satisfying a maximum threshold among the adjacent five past frames including the current frame is counted. A KNN-based neighborhood graph may be constructed that has a maximum number of neighbors equal to a second threshold and L1 distance being used. The result is a set of clusters.

In Block 408, the at least one cluster is labeled with at least one label to generate a labeled cluster. In one or more embodiments, labeling the cluster identifies the LiDAR points in the cluster as being part of the same object, regardless of whether the specific object is identified or even the type of object is identified. For example, labeling may be perfomed by generating bounding boxes around each cluster. A bounding box is a box that uses the farthest points of a cluster in each direction to define the outer surface of the object in one or more embodiments. Bounding boxes, and correspondingly the identification of the cluster, that fail to satisfy a maximum or minimum object size threshold may be removed. Namely, the LiDAR points are still present, but the identification of the cluster or bounding box is removed. Labeling a cluster may further include associating an object identifier with the cluster. The object identifier may be a generic object identifier for the cluster.

Once the clustering is completed in Block 408, the previously removed ground LiDAR points may be added back or reconsidered for the remaining filtering and initial training. By including the previously removed ground, the detector model may be trained to ignore the ground when identifying objects.

In Block 410, a range filtering of the initial set of LiDAR points may be performed to generate a filtered set of LiDAR points. The range filtering removes LiDAR points that fail to satisfy a distance threshold. As discussed above, the distance threshold is defined to differentiate a region that is dense sufficiently to satisfy a threshold level of accuracy from a sparser farther region in which the clustering does not satisfy the threshold accuracy level. In one or more embodiments, the distance may be the distance from the location of the LiDAR sensor to the LiDAR point. If the distance is greater than the distance threshold, then the LiDAR point is omitted from the filtered set of LiDAR points. If the distance is less than the distance threshold, then the LiDAR point is included in the filtered set of LiDAR points. Although distance from the LiDAR sensor is described, distance may be measured in different ways without departing from the scope of the invention. Block 410 may be performed before removing ground or performing the clustering without departing from the scope of the invention.

In Block 412, concurrently with, before, or after the range filtering, but after the clustering, a sparsity simulation filtering may be performed on the initial set of LiDAR points to further generate the filtered set of LiDAR points. The sparsity simulation filtering is defined to imitate the sparsity of the sparse regions that are removed in Block 410. In the sparsity simulation filtering, some LiDAR points are removed from or not included in the filtered set of LiDAR points regardless of whether the LiDAR points are part of a cluster in one or more embodiments.

FIG. 5 shows two possible techniques for sparsity simulation filtering, one or both of which may be performed. Other techniques may be used without departing from the scope of the invention. Turning briefly to FIG. 5, in Block 502, LiDAR beams for dropping are selected to obtain dropped beams. In one or more embodiments, LiDAR points in the LiDAR point clouds are associated with beam identifiers of the LiDAR beams to generate the LiDAR point. The LiDAR beams may be randomly selected as part of the set of dropped beams in one or more embodiments.

In Block 504, the initial set of LiDAR points corresponding to the set of dropped beams are filtered. LiDAR points may be randomly dropped based on the LiDAR points' beam identifiers.

A particular example of performing Blocks 502 and 504 is described below.

One or more embodiments may randomly sample a beam drop ratio from a set of [1, 2, 3]. Then, a starting beam index between zero and the beam drop ratio is randomly sampled. Finally, only the LiDAR points whose beam identifiers minus the starting beam index is a multiple of the beam drop ratio are kept in the set of filtered LiDAR points. In the example, the LiDAR points inside beams that are uniformly spaced according to beam identifiers are kept, and the spacing is determined by the sampled beam drop ratio. Notably, in the example, when the beam drop ratio is one, the LiDAR point cloud does not have any filtering performed for this type of filtering. Further, the preceding is only one example of how sparsity simulation filtering may be performed based on dropping beams. Other techniques may be used without departing from the scope of the invention.

Blocks 506 and 508 show another technique for sparsity simulation filtering. In Block 506, the initial set of LiDAR points are projected in a spherical coordinate system. The centroid or origin of the sphere may be the location of the LiDAR sensor. The 3D LiDAR point cloud may be converted from Euclidean coordinates to spherical coordinates.

In Block 508, the initial set of LiDAR points are filtered using at least one of evenly spaced rows and evenly spaced columns with the initial set of LiDAR points in spherical coordinates. The filtered set of LiDAR points does not include the LiDAR points that are in at least one of the evenly spaced rows in the sphere and the evenly spaced columns when projected into the spherical coordinate system. The spherical coordinates may be discretized according to a predefined resolution. A subsample of the LiDAR points with uniform spacing in the discretized spherical coordinates may be randomly sampled.

A particular example of performing Blocks 506 and 508 is described below. One or more embodiments may convert the 3D LiDAR points whose Euclidean norms are bigger than 0.1 into spherical coordinates (theta, phi, radial_distance). Then, one or more embodiments may randomly sample the discretization resolutions of theta and phi from a predefined set (e.g., [600, 900, 1200, 1500]). Spherical drop ratios may also be randomly sampled. In one or more embodiments, only the LiDAR points inside evenly-spaced discretized spherical coordinates for both rows and columns are kept in the filtered set of LiDAR points, whereby the spacing is determined by the sampled spherical drop ratio.

The processing of FIG. 5 may be performed to help training from near range generalize to longer range.

Returning to FIG. 4, in Block 414, the detector model is initially trained using the filtered set of LiDAR points and the at least one labeled cluster. The detector model uses the filtered set of LiDAR points as the input data and attempts to identify the locations of one or more objects (i.e., predicted objects) from the filtered set of LiDAR points. For example, the detector model may be configured to generate, as output, predicted bounding boxes around the identified objects. The predicted objects are compared to the at least one labeled cluster to generate a loss. The loss is backpropagated through the detector model to update and train the detector model.

The training loss for the detector model may be calculated as a combination of focal loss and rotation-robust generalized intersection-over-union (rgiou) loss. The losses for positive labels and negative labels may be computed and summed separately, both normalized by the number of positive labels. To determine which pixels on the feature map count as positive or negative, the axis-aligned intersection-over-union (IoU) is calculated for the pixels in the output feature map with respect to each object. In other words, the IoU is calculated between a point and a bounding box with different centers but aligned sizes and yaws.

By way of a specific example that may be used in some implementations, for each object, the following operations may be performed. If a pixel exists with the IoU value bigger than a threshold, then a pixel per object is randomly sampled to apply the losses on (e.g., positive focal loss+rgiou loss), and the losses are not applied on other pixels having IoU values greater than the threshold. Otherwise, if there are no pixels in the object with the IoU value bigger than the threshold, then the pixel with the highest IoU value is selected for losses, and the losses are not applied to other pixels. For the pixels that are selected as positive, a positive focal loss and rgiou loss is applied while a negative focal loss is applied for the remaining pixels that are not set to be ignored.

By performing 402-414 on multiple different sets of LiDAR input data corresponding to different LiDAR point clouds, the detector model may be initially trained without human labeling or interaction (i.e., unsupervised). Further, vast amounts of unlabeled training data that already exist may be employed to initially train the detector model.

In one or more embodiments, after the initial training, the detector model processes the initial set of LiDAR points in the LiDAR data to generate labeled objects in Block 416. In one or more embodiments, the detector model processes the full initial set of LiDAR points. The result is a predicted set of labeled objects that the detector model has learned to identify through the training process.

In one or more embodiments, the detector model operates in the same way during training as when detecting objects during use. However, during training, the filtered set of LiDAR points is used whereas the full set of LiDAR points are used when performing detection. Regardless of whether training or detection is used, a prefilter may be applied to limit the LiDAR points for detection to a predefined region of interest. The predefined region of interest may be defined based on external factors, such as the movement and direction of the autonomous system or other factors.

In one or more embodiments, operating the detector may be performed as follows. A voxelizer may generate a voxelized 3D grid from the LiDAR point cloud. The voxelizer produces a binary voxel occupancy map I∈{0,1}^{L×W×D}, where L×W defines the input BEV grid resolution, and D is the number of channels in the height dimension. The detector model may have a ResNet backbone with FPN to produce a four times downsampled feature map, from which a simple convolutional header decodes the bounding box parameters (x, y, l, w, θ) and the confidence c in a dense fashion (i.e., per BEV pixel). In the example, x and y are cartesian coordinate values identifying a location of a corner of the bounding box; l and w are length and width, respectively, of the bounding box; and θ is the heading direction of the object in the bounding box. The set of objects that are detected may be obtained by applying confidence thresholding to the confidence c and non-maximum suppression (NMS). Thus, the result is a set of bounding boxes defined by the bounding box parameters around a set of detected objects.

The training in FIG. 4 shows an unsupervised training process. For supervised training, the system may receive prelabeled LiDAR point clouds and perform Blocks 414 and 416 using the labeled LiDAR point clouds. Regardless of whether supervised or unsupervised training is used, one or more embodiments may perform iterative training of the detector model. In the iterative training process, as the detector model is in use, the training of the detector model is used to continually update the detector model. The detector model detecting an object over a series of frames is used as a proxy for identifying a detection as correct.

FIG. 6 shows an example of unsupervised iterative training of the detector model in accordance with one or more embodiments. In Block 602, a set of new positions of a set of objects in a geographic region is forecasted based on a first set of object tracks to obtain a set of forecasted object positions. For each object, if the object is detected at least twice, then the forecasted new position of the object may be performed by assuming constant velocity in the direction defined by the heading. If the object is only detected in one prior frame, then the forecasted object position may use the same position as the prior frame based on an assumption that the object remains still.

For example, the following operation may be performed. For each new frame at time step t with detections Bₜ={bₜ^{l}} where each bₜ^{l}=(xₜ^{l}, yₜ^{l}, lₜ^{l}, wₜ^{l}, θₜ^{l}) ∈ [symbol] ⁵ is the individual 2D birds eye view bounding box, the following operation may be performed. For each tracklet j of an object, the forecasted position (xₜ^{j}, yₜ^{j}) of the object at time t is either (1) if the tracklet has at least two past frames, one or more embodiments set (xₜ^{j}, yₜ^{j})=2*(xₜ₋₁^{j}, yₜ₋₁^{j})−(xₜ₋₂^{j}, yₜ₋₂^{j}) via naive extrapolation assuming constant velocity between two adjacent frames; or otherwise (2) (xₜ^{j}, yₜ^{j})=(xₜ₋₁^{j}, yₜ₋₁^{j}).

More robust forecasting may be performed. For example, the forecasting may be based on the acceleration of the object if the object is in at least three preceding frames or, if the object is detected as turning, then a different direction of the object. Further, rather than only forecasting the object position in 2D space, the object position in 3D space may be forecasted.

In Block 604, a new LiDAR point cloud of the geographic region is obtained. Obtaining the new LiDAR point cloud may be performed as discussed above with reference to Block 402 of FIG. 4.

In Block 606, the detector model processes the new LiDAR point cloud to obtain a new set of bounding boxes around the set of objects detected in the new LiDAR point cloud. The processing by the detector model may be performed as discussed above with reference to Block 416.

In Block 608, the new set of bounding boxes are matched to the set of forecasted object positions to generate a set of matches. The matching is performed to associate the bounding box with an object and object track. Specifically, each frame is an individual and distinct detection of objects in a LiDAR point cloud. The computing system has to relate new detection of objects to past detections in order to track the object over time. The matching process is a process to predict which bounding box in the new set of bounding boxes corresponds to a prior detection of an object. To perform the matching process, in one or more embodiments, the Euclidean distance between the forecasted object position and the new set of bounding boxes is determined. For example, the Euclidean distance may be calculated between pairs having a predefined point on the object (e.g., the center of the respective bounding box or another predefined point) and the corresponding predefined point on the new set of bounding boxes. Matching may be performed greedily by iteratively: selecting pairs having the smallest distance as a match and removing the pairs that have the same new bounding box or forecasted position as the matched pair. Pairs having a distance greater than a maximum distance threshold may be removed as not matching.

Stated another way, the matching may proceed as follows. For each pair of the detected bounding boxes bₜ^{l} and the forecasted object position defined by the bounding box bₜ^{j}, the Euclidean distance may be computed between the bounding box centroids as [symbol] ^{j,l}=\sqrt{(xₜ^{j}−xₜ^{l})²+(yₜ^{j}−yₜ^{l})².} For each existing object track, a greedy strategy may be performed to find the nearest detection l*=arg minₗ [symbol] ^{j,l}. If the closest distance l^{j,l}* is greater than the maximum distance threshold, then the object has no match.

Although the above is one matching strategy, other matching strategies may be used without departing from the scope of the invention.

In Block 610, the first set of object tracks are updated with the new set of bounding boxes according to the set of matches to obtain an updated set of object tracks. The new position of the object is added to the object track for the object. Because objects generally do not disappear, if an object is not matched, then the forecasted object position may be added to the object track. If a new bounding box detection of an object is not matched, then a new object track may be generated for the object.

Further, one or more embodiments may associate a confidence score with the object track. If an object track is matched to a new bounding box, the new bounding box is added to the object track, and the confidence score for the object track is updated to

$${c}_{t}^{j} = \frac{w \cdot {c}_{t - 1}^{j} + {c}_{t}^{l}}{w + 1.} ,$$

where cₜ₋₁^{j} is the prior confidence score for the track, cₜ^{l}=1.0 is the detection confidence score of a new bounding box, and w=Σᵢ₌₁ⁿ^{_{t−1}}^{^{j}}=0.9ⁱ where nₜ₋₁^{j} is the number of tracking steps in the object track.

If an object track is not matched, the object track is increased as discussed above and the new confidence score of the object track is set as cₜ^{j}=0.9cₜ₋₁^{j}. If a new bounding box is not matched, a new object track is defined with a confidence score cₜ^{j}=0.9.

Object tracks with a confidence score below an object track confidence score threshold may be removed. Further, NMS may be applied at the end over existing object tracks in the current frame with an IoU threshold of 0.1.

The specific numbers used in the confidence scores and the confidence score thresholds are for illustrative purposes only and are not intended to limit the scope of the invention.

In one or more embodiments, Blocks 602-610 are performed over a sequence of sensing frames before continuing to filtering and training the detector model. By performing Blocks 602-610 over a sequence of frames, objects that newly enter the geographic region have a chance to remain past the subsequent filtering.

Further, in one or more embodiments, the object tracks are defined in both the forward and the reverse direction of time. Specifically, two sets of object tracks are defined: a first set of object tracks and a second set of object tracks, whereby the second set of object tracks are in a temporally reversed direction from the first set of object tracks (i.e., either in the forward in time or backward in time direction). A temporal consistency score may be associated with the detection of an object, objects that have low temporal consistency scores may be filtered out.

In Block 612, after updating, the updated set of object tracks are filtered to remove object tracks failing to satisfy a track length threshold and to generate a training set of object tracks. In one or more embodiments, for each object, the maximum of (i) the length of the object track in the forward direction and (ii) the length of the object track in the reverse direction is determined. Then, for the object, the maximum is compared to the track length threshold. If the maximum fails to satisfy the track length threshold, then the object, and correspondingly, the object track is not used in the training of the detector model. If the maximum satisfies the track length threshold (e.g., at least one object track of the object is greater than the track length threshold), then the object is used for the training in Block 620 described below. Notably, the track confidence scores may already have been used to filter out some objects. The training set of object tracks are the object tracks that are not filtered out in the filtering process based on the track length threshold or the object track confidence score.

In Block 614, at least a subset of the new set of bounding boxes that are in the training set of object tracks are selected. The new set of bounding boxes that are in the training set of object tracks are identified and used as the labeled bounding boxes for the purposes of retraining the detector model in Block 620. Because some of the object tracks may be filtered out, some of the bounding boxes in the new set of bounding boxes may optionally be filtered out.

Optionally, revisions on the bounding boxes may be performed. Specifically, in Block 616, for at least one bounding box in the subset, the bounding box is revised according to the remaining bounding boxes in the object track. In one or more embodiments, due to the tightest-box-fitting nature of the initial clustering labels in FIG. 4, the bounding box sizes in [symbol] ^{(k)} are smaller for partially observed objects, especially for those farther away from the LiDAR sensor. To address the size difference, for each object track, a new length and width of the object may be set as the top r percentile of all lengths and all widths detected throughout the object track. Next, a corner-based alignment strategy may be performed by finding the bounding box corner that is the closest to the LiDAR sensor. The bounding box center is then updated with the anchored corner, the original bounding box heading, and the new bounding box size.

In Block 618, a sparsity simulation filter may be applied to a new set of LiDAR points in the new LiDAR point cloud to obtain a revised new LiDAR point cloud. In one or more embodiments, the sparsity simulation filtering may perform one or both techniques of FIG. 5. For example, the sparsity simulation filter may perform the beam dropping described by Blocks 502 and 504 of FIG. 5.

In Block 620, the detector model is retrained using the at least the subset of the new set of bounding boxes and the revised new LiDAR point cloud. Retraining the detector model may be performed as discussed above with reference to Block 414. Specifically, the detector model processes the revised new LiDAR point cloud to generate a set of predicted detected objects. The set of predicted objects are compared to the at least the subset of the new set of bounding boxes after the filtering to determine a loss, which is backpropagated through the detector model. Thus, the detector model is updated.

In Block 622, a determination is made whether to continue training. If a determination is made to continue training, the process repeats with Block 602. If a determination is made not to continue training, the process proceeds to end. In one or more embodiments, the detector model may be iteratively trained during use. For example, the processing of FIG. 6 may be performed as long as the detector model is being used to detect objects. Alternatively, the iterative updating may be performed at defined intervals during the use of the detector model.

Although not explicitly described above, at the same time that the detector model is being iteratively updated, the detector model may also be used to detect objects output the detected objects. For example, the output of Block 606 may be used by a virtual driver to determine an action of the autonomous system. For example, the detected positions of objects may be used to predict future positions of the objects and determine an action that the autonomous system should perform. For example, the action may be to initiate a signal, turn, slow down, speed up, stay the same speed, wait, etc. based on the detected objects and any predictions. Because the detector model is continually updating, the operations of the virtual driver and, correspondingly, the autonomous system is improved.

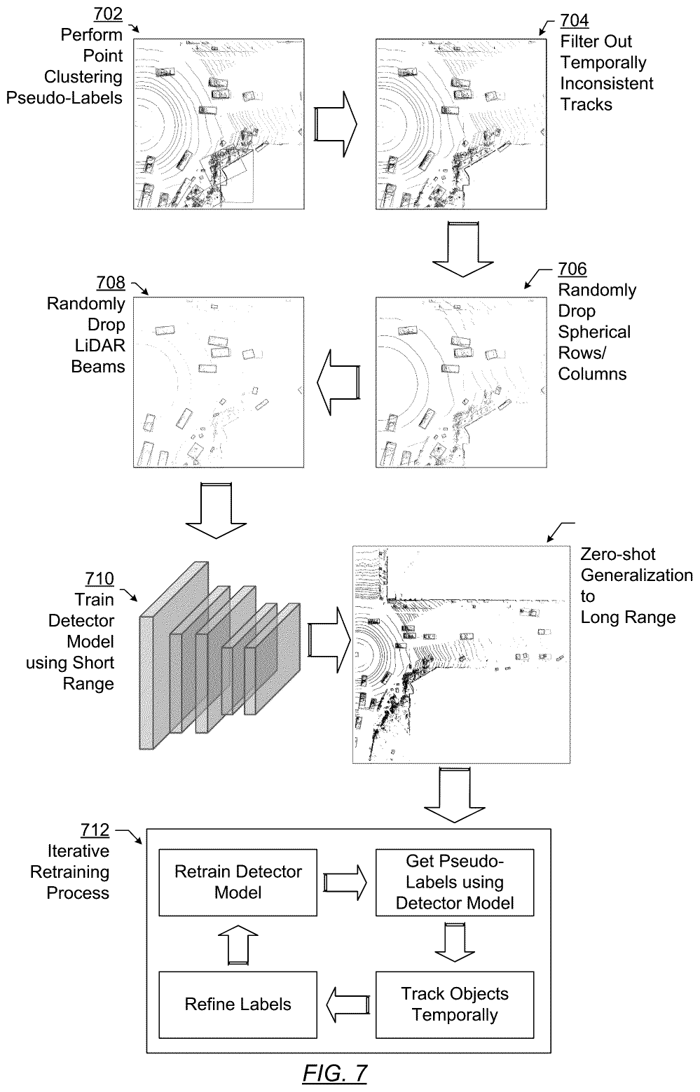

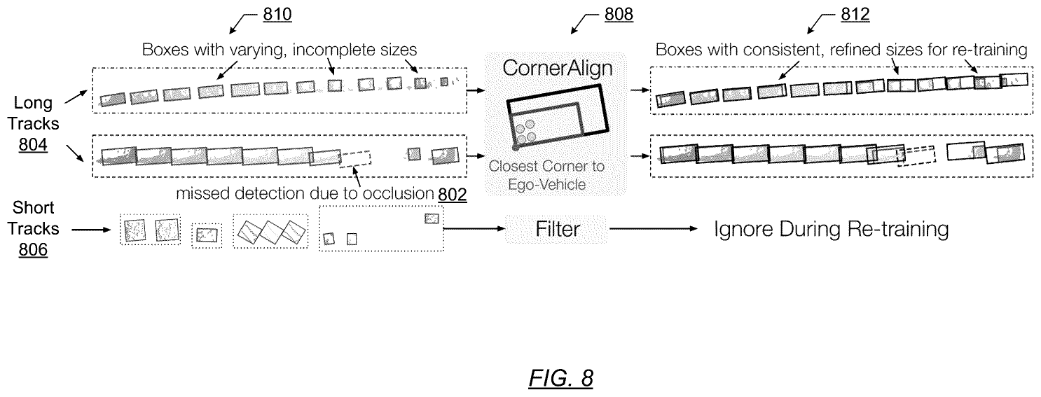

Turning to the example, FIGS. 7 and 8 show examples in accordance with one or more embodiments. The following examples are for explanatory purposes only and are not intended to limit the scope of the invention.

FIG. 7 shows a flow diagram for the initial and iterative training of the detector model in accordance with one or more embodiments. First, point clustering is performed on the LiDAR point cloud to generate pseudo-labels (702). LiDAR points are clustered and bounding boxes are added around the LiDAR points. Next, temporally inconsistent tracks are filtered out to remove some of the pseudo-labels shown on the LiDAR point cloud (704). The initial training may also include temporal filtering described above with reference to FIG. 6. To perform the temporal filtering, the iterative detections are based on clustering rather than the output of the detector model.

Further, spherical rows and columns are randomly dropped to create LiDAR point cloud (706) and LiDAR beams are randomly dropped as shown in LiDAR point cloud (708). The result LiDAR point cloud is initial training data.

In 710, the resulting LiDAR point cloud is provided to the detector model to train the detector model using short range data. In the example, the inputs to the detector model are 3D voxelized binary LiDAR images from Bird-Eye View (BEV), with front-range region of interest (ROI) of zero to eighty meters longitudinally and negative forty to positive forty meters laterally with respect to the traveling direction of the ego vehicle. The step size of the voxel in BEV may be around two-tenths of a meter in the example to produce an input feature resolution. In the z-axis of the voxels, the height may be set to six meters with a step size of two-tenths of a meter. Multiple voxelized frames may be grouped together. The decoder model may be similar to ResNet with a Feature Pyramid Network (FPN). The ResNet backbone may have initial stem layers which downsample the feature resolution two times, and then three residual stages, each of which downsamples the feature resolution by another two times. The detector model may also include normalization layers, such as Sync BatchNorm (SyncBN), with weights and biases initialized to zero. The FPN inputs have downsampled resolutions with multiple channels, which are combined to produce a feature map. After FPN, separate headers may be used for the classification branch and the regression branch. The classification branch may have four layers of (conv3×3→SyncBN→ReLU) with channel size 48 and then a conv1×1 layer at the end. The classification branch may produce binary classification logits to predict the presence of class-agnostic objects. The regression branch may predict a 6-dimensional vector (dx, dy, logl, logw, sinθ, cosθ), where (dx, dy) represent the predicted offsets of object centers from the BEV meshgrid, and (logl, logw) represent the log of the predicted physical lengths of the objects in terms of meters. The outputted values for (sinθ, cosθ) may be unconstrained.

Next, an iterative retraining process is performed (712). The iterative retraining process may follow the process of FIG. 6. Specifically, pseudo-labels are obtained using the detector model, objects are tracked temporally to generate object tracks, the pseudo-labels are refined based on the object tracks, and the detector model is retrained using the refined labels. As shown in FIG. 7, the retraining may be continually performed without human interaction. Thus, embodiments provide a technique for the computing system to self improve detection capabilities using LiDAR.

FIG. 8 shows an example of refinement in accordance with one or more embodiments. With unsupervised tracking, missed detections are filled in as shown in the added box (802). Further, per object tracks (i.e., long tracks (804), short tracks (806)) are defined. For long object tracks (804), temporal observations are leveraged to find a new, consistent object size. For example, the refinement process (808) changes inconsistent bounding boxes (810) to consistent bounding boxes (812). As shown, the initial bounding boxes are updated with the alignment strategy. Further short tracks (806) are filtered out during retraining to not be used during the retraining process.

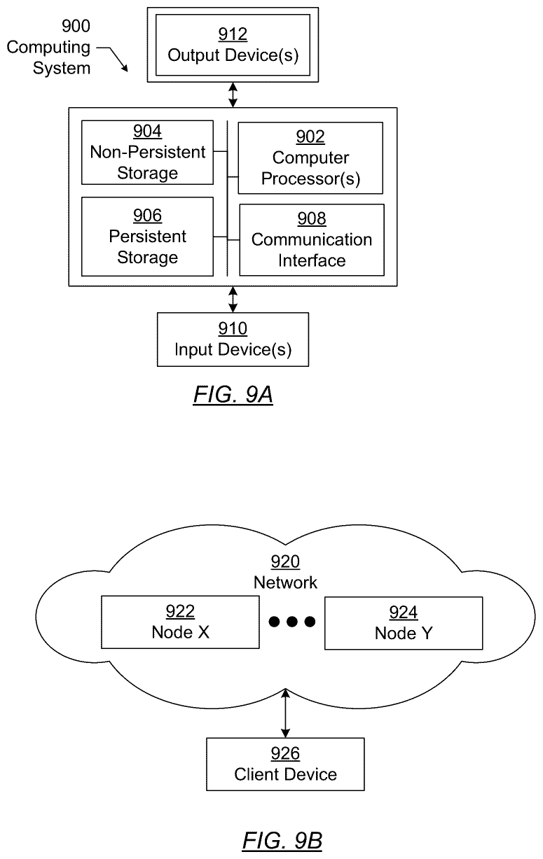

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 9A, the computing system (900) may include one or more computer processors (902), non-persistent storage (904), persistent storage (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) may be one or more cores or micro-cores of a processor. The computer processor(s) (902) includes one or more processors. The one or more processors may include a central processing unit (CPU), a graphics processing unit (GPU), a tensor processing unit (TPU), combinations thereof, etc.

The input devices (910) may include a touchscreen, keyboard, mouse, microphone, touchpad, electronic pen, or any other type of input device. The input devices (910) may receive inputs from a user that are responsive to data and messages presented by the output devices (912). The inputs may include text input, audio input, video input, etc., which may be processed and transmitted by the computing system (900) in accordance with the disclosure. The communication interface (908) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the output devices (912) may include a display device, a printer, external storage, or any other output device. One or more of the output devices may be the same or different from the input device(s). The input and output device(s) may be locally or remotely connected to the computer processor(s) (902). Many different types of computing systems exist, and the aforementioned input and output device(s) may take other forms. The output devices (912) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9A. Further, the client device (926) may include and/or perform all or a portion of one or more embodiments.

The computing system of FIG. 9A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
forecasting a set of new positions of a set of objects in a geographic region based on a first set of object tracks to obtain a set of forecasted object positions;
obtaining a new LiDAR point cloud of the geographic region;
processing, by a detector model, the new LiDAR point cloud to obtain a new set of bounding boxes around the set of objects detected in the new LiDAR point cloud;
matching the new set of bounding boxes to the set of forecasted object positions to generate a set of matches;
updating the first set of object tracks with the new set of bounding boxes according to the set of matches to obtain an updated set of object tracks;
filtering, after updating, the updated set of object tracks to remove object tracks failing to satisfy a track length threshold, to generate a training set of object tracks;
selecting at least a subset of the new set of bounding boxes that are in the training set of object tracks; and
retraining the detector model using the at least the subset of the new set of bounding boxes.

2. The method of claim 1, further comprising:
obtaining the first set of object tracks of the set of objects in the geographic region at least by processing, by the detector model, a plurality of LiDAR point clouds of the geographic region over a span of time to detect a set of bounding boxes around the set of objects in the plurality of LiDAR point clouds.

3. The method of claim 1, wherein the detector model is an unsupervised model.

4. The method of claim 1, further comprising:
generating, using the new LiDAR point cloud, a second set of object tracks of the set of objects, wherein the second set of object tracks are in a temporally reversed direction from the first set of object tracks; and
filtering the second set of object tracks to remove object tracks failing to satisfy the track length threshold, and to further generate the training set of object tracks,
wherein the training set of object tracks are in a temporally forward direction and the temporally reverse direction.

5. The method of claim 1, further comprising:
for at least one bounding box in the at least the subset of the new set of bounding boxes, revising the bounding box according to remaining bounding boxes in a corresponding object track of the first set of object tracks.

6. The method of claim 1, further comprising:
performing a sparsity simulation filter on a new set of LiDAR points in the new LiDAR point cloud to obtain a revised new LiDAR point cloud, wherein retraining the detector model further uses the revised new LiDAR point cloud.

7. The method of claim 1, further comprising:
obtaining an initial set of LiDAR points in LiDAR data;
removing a set of ground LiDAR points from the initial set of LiDAR points corresponding to ground to obtain a revised set of LiDAR points;
clustering, by a clustering algorithm, the revised set of LiDAR points to obtain at least one cluster;
labeling the at least one cluster with at least one label to generate at least one labeled cluster; and
initially training the detector model using the initial set of LiDAR points and the at least one labeled cluster.

8. The method of claim 7, further comprising:
filtering, after clustering and prior to the initial training, the initial set of LiDAR points to imitate sparsity to obtain a filtered set of LiDAR points, wherein the initial training is performed on the filtered set of LiDAR points; and
processing, after the initial training and by the detector model, the initial set of LiDAR points in the LiDAR data to generate a first plurality of labeled objects.

9. The method of claim 1, further comprising:
obtaining an initial set of LiDAR points in LiDAR data;
clustering, by a clustering algorithm, the initial set of LiDAR points to obtain at least one cluster;
labeling the at least one cluster with at least one label to generate at least one labeled cluster;
performing a range filtering of the initial set of LiDAR points to obtain a filtered set of LiDAR points, wherein the range filter removes points satisfying a distance threshold; and
initially training the detector model using the filtered set of LiDAR points and the at least one labeled cluster.

10. The method of claim 9, further comprising:
performing a sparsity simulation filtering of the initial set of LiDAR points to further generate the filtered set of LiDAR points.

11. The method of claim 10, wherein performing the sparsity simulation filtering comprises:
selecting a set of LiDAR beams for dropping to obtain a set of dropped beams; and
filtering the initial set of LiDAR points corresponding to the set of dropped beams.

12. The method of claim 10, wherein performing the sparsity simulation filtering comprises:
projecting the initial set of LiDAR points in spherical coordinates; and
filtering the initial set of LiDAR points using at least one of evenly spaced rows and evenly spaced columns with the initial set of LiDAR points in spherical coordinates.

13. The method of claim 1, further comprising:
obtaining an initial set of LiDAR points in LiDAR data;
clustering, by a clustering algorithm, the initial set of LiDAR points to obtain at least one cluster;
labeling the at least one cluster with at least one label to generate at least one labeled cluster;
performing a sparsity simulation filtering of the initial set of LiDAR points within a threshold distance to generate the filtered set of LiDAR points; and
initially training the detector model using the filtered set of LiDAR points and the at least one labeled cluster.

14. A system comprising:
one or more computer processors; and
a non-transitory computer readable medium comprising computer readable program code for causing the one or more computer processors to perform operations comprising:
forecasting a set of new positions of a set of objects in a geographic region based on a first set of object tracks to obtain a set of forecasted object positions;
obtaining a new LiDAR point cloud of the geographic region;
processing, by a detector model, the new LiDAR point cloud to obtain a new set of bounding boxes around the set of objects in a plurality of LiDAR point clouds;
matching the new set of bounding boxes to the set of forecasted object positions to generate a set of matches;
updating the first set of object tracks with the new set of bounding boxes according to the set of matches to obtain an updated set of object tracks;
filtering, after updating, the updated set of object tracks to remove object tracks failing to satisfy a track length threshold, to generate a training set of object tracks;
selecting at least a subset of the new set of bounding boxes that are in the training set of object tracks; and
retraining the detector model using the at least the subset of the new set of bounding boxes.

15. The system of claim 14, wherein the operations further comprise:
obtaining the first set of object tracks of the set of objects in the geographic region at least by processing, by the detector model, the plurality of LiDAR point clouds of the geographic region over a span of time to detect a set of bounding boxes around the set of objects in the plurality of LiDAR point clouds.

16. The system of claim 14, wherein the operations further comprise:
generating, using the new LiDAR point cloud, a second set of object tracks of the set of objects, wherein the second set of object tracks are in a temporally reversed direction from the first set of object tracks; and
filtering the second set of object tracks to remove object tracks failing to satisfy the track length threshold, and to further generate the training set of object tracks,
wherein the training set of object tracks are in a temporally forward direction and the temporally reverse direction.

17. The system of claim 14, wherein the operations further comprise:
for at least one bounding box in the at least the subset of the new set of bounding boxes, revising the bounding box according to remaining bounding boxes in a corresponding object track of the first set of object tracks.

18. The system of claim 14, wherein the operations further comprise:
obtaining an initial set of LiDAR points in LiDAR data;
clustering, by a clustering algorithm, the initial set of LiDAR points to obtain at least one cluster;
labeling the at least one cluster with at least one label to generate at least one labeled cluster;
performing a range filtering of the initial set of LiDAR points to obtain a filtered set of LiDAR points, wherein the range filter removes points satisfying a distance threshold; and
initially training the detector model using the filtered set of LiDAR points and the at least one labeled cluster.

19. The system of claim 18, wherein the operations further comprise:
performing a sparsity simulation filtering of the initial set of LiDAR points to further generate the filtered set of LiDAR points.

20. A non-transitory computer readable medium comprising computer readable program code for causing a computer system to perform operations comprising:
forecasting a set of new positions of a set of objects in a geographic region based on a first set of object tracks to obtain a set of forecasted object positions;
obtaining a new LiDAR point cloud of the geographic region;
processing, by a detector model, the new LiDAR point cloud to obtain a new set of bounding boxes around the set of objects in a plurality of LiDAR point clouds;
matching the new set of bounding boxes to the set of forecasted object positions to generate a set of matches;
updating the first set of object tracks with the new set of bounding boxes according to the set of matches to obtain an updated set of object tracks;
filtering, after updating, the updated set of object tracks to remove object tracks failing to satisfy a track length threshold, to generate a training set of object tracks;
selecting at least a subset of the new set of bounding boxes that are in the training set of object tracks; and
retraining the detector model using the at least the subset of the new set of bounding boxes.
